(19) United States
(12) Patent Application Publication
(10) Pub. No.: US 2008/0057173 A1
(43) Pub. Date: Mar. 6, 2008

(54) Apparatus for drying food waste

(76) Inventor: Soon Bong Kim, Kangwon-do (KR)

Correspondence Address: JACKSON WALKER LLP, 901 MAIN STREET, SUITE 6000, DALLAS, TX, 75202-3797, US

(21) Appl. No.: 11/895,764

(22) Filed: Aug. 27, 2007

(30) Foreign Application Priority Data
Aug. 30, 2006 (KR) 10-2006-0083164

(51) Int. Cl. A23L 3/40

(52) U.S. Cl. 426/456

(57) ABSTRACT

Disclosed herein is an apparatus for drying food waste. In the apparatus according to the present invention, food waste, which is put into a food waste receptacle, is primarily separated into solid and liquid fractions by a support screen relatively thoroughly. Thereafter, the upper and lower parts of the food waste are heated and dried at the same time, and the liquid is simultaneously heated and dried. Therefore, the present invention can increase the efficiency with which food waste is dried, compared to the conventional food waste drying apparatus.

### BACKGROUND OF THE INVENTION

1. Field of the Invention

The present invention relates generally to apparatuses for drying food waste and, more particularly, to an apparatus for drying food waste which has a structure suitable for home use.

2. Description of the Related Art

As well known to those skilled in the art, apparatuses for drying food waste for home use serve to dry food waste containing a relatively large quantity of water to reduce the weight thereof such that users can conveniently discard the food waste. A representative example of such apparatuses for drying food waste was proposed in Korean Patent Publication No. 10-2006-4601 (Jan. 12, 2006). In the food waste drying apparatus according to this technique, air, which is forcibly circulated by a blower, is heated by a heater at a relatively high temperature. The heated air passes around the upper space in a food waste receptacle and is discharged outside the food waste receptacle.

The disclosed food waste apparatus has a relatively simple structure, so that there are advantages in that the economic burden of a manufacturing process and upon use thereof is reduced. However, the conventional food waste apparatus is disadvantageous in that the drying efficiency is relatively low. In detail, in the process in which high-temperature air passes around the upper space in the food waste receptacle and is discharged outside the food waste receptacle, even though the upper part of the food waste, which has been put in the food waste receptacle, is dried relatively thoroughly, the middle and lower parts of the food waste are insufficiently dried. That is, the efficiency of drying of the food waste is reduced from the upper part of the food waste to the lower part thereof. Although the time required for drying the food waste varies depending on the amount of food waste, low drying efficiency is the great disadvantage of the conventional food waste drying apparatus.

As another example of the food waste drying apparatuses, an apparatus, in which several heating wires or a heater are installed in the lower end of a main body of an apparatus having a food waste receptacle therein, was proposed. In this technique, the upper and lower parts of the food waste are heated at the same time, so that an increase in drying efficiency is expected. However, because this apparatus has a complex structure, there are problems in that the cost of manufacturing the apparatus, power consumption and the incidence of malfunction are increased.

### SUMMARY OF THE INVENTION

Accordingly, the present invention has been made keeping in mind the above problems occurring in the prior art, and, particularly, the present invention improves on the structure of the food waste drying apparatus disclosed in Korean Utility Model Registration No. 397143.

An object of the present invention is to provide an apparatus for drying food waste which can enhance the efficiency with which food waste is dried despite having a simple structure. This object of the present invention is realized through a structure in which high-temperature air, which is circulated by a blower, is supplied into the upper and lower spaces in the food waste receptacle at the same time.

In order to accomplish the above object, the present invention provides an apparatus for drying food waste, including: a housing to removably receive a food waste receptacle therein; a blower provided at a predetermined position in an upper surface of the housing and communicating with an interior of the housing; a duct provided to communicate with the blower, with a discharge passage provided in the duct for discharging air, and a first circulation passage and a second circulation passage provided in the duct and respectively connected to upper and lower portions of the food waste receptacle; an electric heater provided in the first circulation passage; and the food waste receptacle, with a support screen provided in the food waste receptacle to support the food waste at a position higher than a bottom of the food waste receptacle, the food waste receptacle having an air inlet, connected to the second circulation passage, and an air outlet at predetermined positions lower than the support screen.

### BRIEF DESCRIPTION OF THE DRAWINGS

The above and other objects, features and advantages of the present invention will be more clearly understood from the following detailed description taken in conjunction with the accompanying drawings, in which:

FIG. 1 is an exploded perspective view showing the construction of an apparatus for drying food waste, according to an embodiment of the present invention;

FIG. 2 is a detailed view illustrating a main body of FIG. 1; and

FIG. 3 is a detailed view illustrating a duct of FIG. 1.

### DESCRIPTION OF THE PREFERRED EMBODIMENTS

Hereinafter, a preferred embodiment of the present invention will be described in detail with reference to the attached drawings.

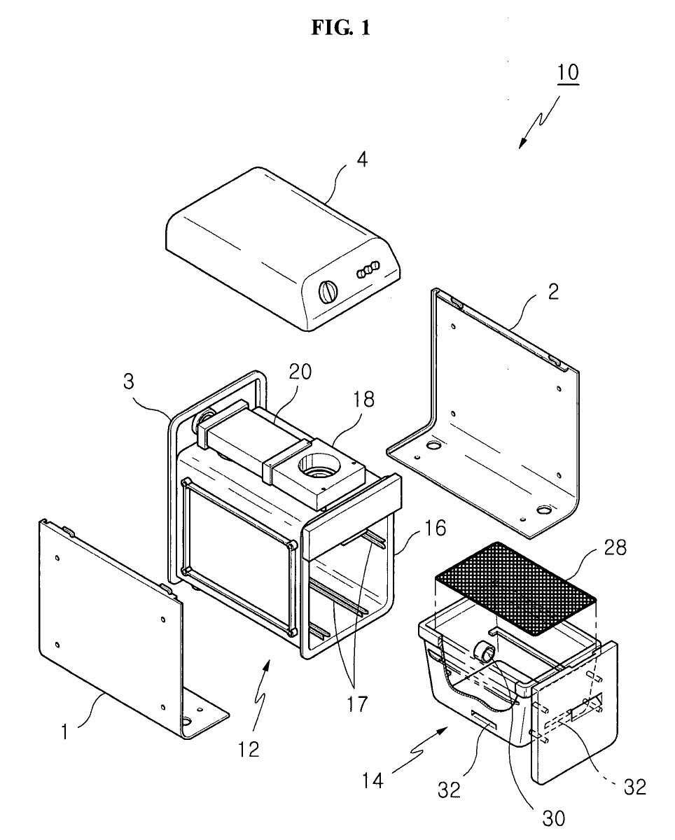

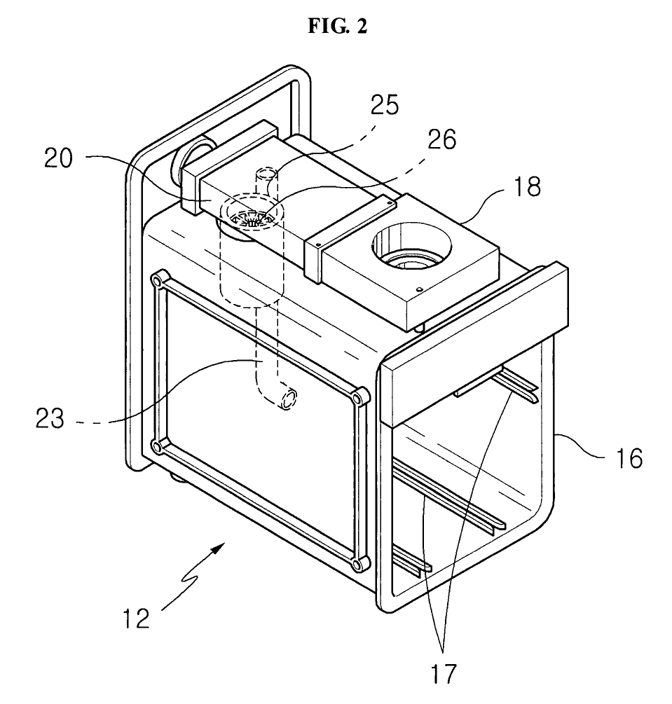

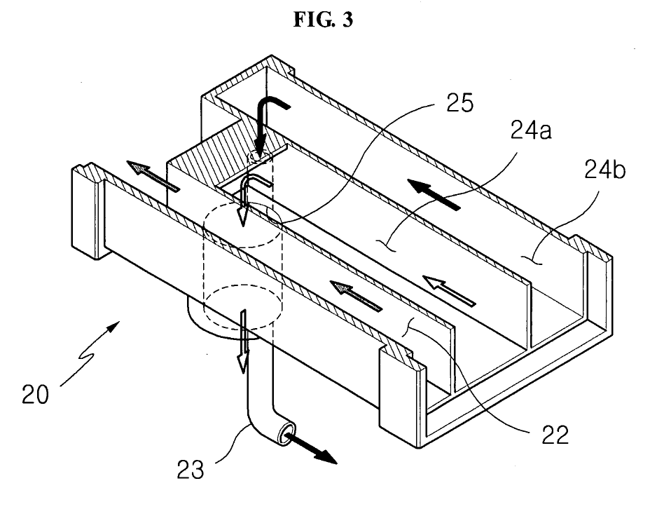

FIG. 1 is an exploded perspective view showing the construction of an apparatus for drying food waste, according to the embodiment of the present invention. FIG. 2 is a detailed view illustrating a main body 12 of FIG. 1. FIG. 3 is a detailed view illustrating a duct 20 of FIG. 1.

In the drawings, the apparatus for drying food waste according to the present invention is designated by the reference numeral 10. As shown in FIG. 1, the food waste drying apparatus 10 includes left and right side plates 1 and 2, a rear plate 3 and an upper plate 4, which are separately provided. Various switches and buttons are provided on the upper plate 4. Here, the bounds of the present invention are not restricted by these components. Furthermore, the food waste drying apparatus 10 further includes the main body 12 and a food waste receptacle 14.

The main body 12 includes a housing 16, which removably receives the food waste receptacle 14 therein, and a blower 18, which is provided at a predetermined position in the upper surface of the housing 16 and communicates with the interior of the housing 16. The main body 12 further includes the duct 20, which communicates with the blower 18, and an electric heater 26. The duct 20 has therein a discharge passage 22, through which air is discharged, and a first circulation passage 24a and a second circulation passage 24b, through which air is supplied into the housing 16. The electric heater 26 is provided in the first circulation passage 24a. The first circulation passage 24a and the second circulation passage 24b are constructed such that, when the food waste receptacle 14 is placed in the apparatus, the first and second circulation passages 24a and 24b respectively extend to the upper and lower parts of the food waste receptacle 14.

The housing 16 has an opening on the front end thereof. The food waste receptacle 14 is removably inserted into the housing 16 through the opening. In the drawings, the reference numeral 17 denotes guide rails, through which the insertion and removal of the food waste receptacle 14 can be smoothly conducted. The blower 18 is provided in the upper surface of the housing 16 and communicates with the interior of the housing 16 through a through hole (not shown).

The duct 20 is disposed on the upper surface of the housing 16 and communicates with the blower 18. As described above, the duct 20 has the single discharge passage 22 and the two circulation passages 24a and 24b. The first circulation passage 24a communicates with the upper space in the food waste receptacle 14 through a through hole 25, and the second circulation passage 24b is connected to an air inlet 30 of the food waste receptacle 14 through a connection pipe 23, which extends from the second circulation passage 24b.

The food waste receptacle 14 includes therein a support screen 28, which supports food waste such that the food waste is maintained at a position higher than the bottom of the food waste receptacle 14. The air inlet 30, which is connected to the second circulation passage 24b through the connection pipe 23, and an air outlet 32, which communicates with the air inlet 30, are formed at predetermined positions in the lower part of the food waste receptacle 14 below the support screen 28. In this embodiment, the apparatus is constructed such that high-temperature air, which has passed through the air outlet 32, is drawn and circulated by the blower 18, but it may be constructed such that the air outlet 32 is connected to a discharge pipe so that high-temperature air, which has passed through the air outlet 32, is discharged outside.

To operate the food waste drying apparatus 10, after an appropriate amount of food waste is put in the food waste receptacle 14, the food waste receptacle 14 is inserted into the housing 16. At this time, a relatively large amount of the water contained in the food waste falls onto and is collected on the bottom of the food waste receptacle 14 through the support screen 28. In other words, the support screen 28 serves to primarily separate the food waste into solid and liquid fractions relatively thoroughly.

In this state, when power is applied to the food waste drying apparatus 10, air in the housing 16 is forcibly circulated by the blower 18. In this process, while air passes through the duct 20, some of the air passes through the discharge passage 22, and the remaining air passes through the circulation passages 24a and 24b.

Air, which passes through the first circulation passage 24a, is heated by the electric heater 26 at a relatively high temperature. The high-temperature air is supplied into the upper space of the food waste receptacle 14 to heat and dry the food waste in a direction from the upper part of the food waste to the lower part thereof in the food waste receptacle 14 and, thereafter, is again drawn into the duct 20 by the blower 18.

Some of the high-temperature air, which is drawn into the duct 20, passes through the discharge passage 22, and the remaining air again passes through the circulation passages 24a and 24b. Meanwhile, high-temperature air, which passes through the second circulation passage 24b, is supplied into the food waste receptacle 14 below the support screen 28 through the connection pipe 23 and the air inlet 30.

The air, which has been supplied below the support screen 28 into the food waste receptacle 14, heats and dries the food waste on the support screen 28 in an upward direction, that is, in a direction from the lower part of the food waste to the upper part thereof. Simultaneously, the air heats and dries liquid, which has been collected on the bottom in the food waste receptacle 14, and, subsequently, is discharged through the air outlet 32. Here, preferably, a porous member is provided in the air outlet 32 such that the heated air remains in the air outlet 32 for a relatively long time.

As such, in the food waste drying apparatus 10 according to the present invention, when food waste is put into the food waste receptacle 14, the food waste is primarily separated into solid and liquid fractions by the support screen 28 relatively thoroughly. Thereafter, the upper and lower parts of the food waste are heated and dried at the same time, and the liquid is simultaneously heated and dried. Therefore, the present invention can increase the efficiency with which food waste is dried, compared to the conventional food waste drying apparatus.

As described above, an apparatus for drying food waste according to the present invention is constructed such that high-temperature air, which is circulated by a blower, is supplied to the upper and lower parts of the food waste. Thus, the upper and lower parts of the food waste are heated and dried at the same time. Therefore, the efficiency with which food waste is dried is markedly enhanced.

Furthermore, the above-mentioned operation and effect are realized by a structure such that the circulation passages of a duct communicate with a food waste receptacle. In other words, the present invention does not require a separate means for heating the lower part of the food waste. Therefore, there is an advantage in that the construction of the apparatus is simplified.

Although the preferred embodiment of the present invention has been disclosed for illustrative purposes, those skilled in the art will appreciate that various modifications, additions and substitutions are possible, without departing from the scope and spirit of the invention as disclosed in the accompanying claims.

What is claimed is:

1. An apparatus for drying food waste, comprising:
a housing to removably receive a food waste receptacle therein;
a blower provided at a predetermined position in an upper surface of the housing and communicating with an interior of the housing;
a duct provided to communicate with the blower, with a discharge passage provided in the duct for discharging air, and a first circulation passage and a second circulation passage provided in the duct and respectively connected to upper and lower portions of the food waste receptacle;
an electric heater provided in the first circulation passage; and
the food waste receptacle, with a support screen provided in the food waste receptacle to support the food waste at a position higher than a bottom of the food waste receptacle, the food waste receptacle having an air inlet, connected to the second circulation passage, and an air outlet at predetermined positions lower than the support screen.

2. The apparatus as set forth in claim 1, wherein the air outlet of the food waste receptacle is connected to an outside discharge pipe.

3. The apparatus as set forth in claim 1, wherein the second circulation passage of the duct is connected to the air inlet of the food waste receptacle through a connection pipe.

4. The apparatus as set forth in claim 1, wherein a porous member is provided in the air outlet of the food waste receptacle.

5. The apparatus as set forth in claim 2, wherein the second circulation passage of the duct is connected to the air inlet of the food waste receptacle through a connection pipe.

6. The apparatus as set forth in claim 2, wherein a porous member is provided in the air outlet of the food waste receptacle.
